(19) United States
(12) Patent Application Publication
(10) Pub. No.: US 2017/0123521 A1
(43) Pub. Date: May 4, 2017

(54) ELECTRONIC CALLIGRAPHIC PEN AND ITS METHOD OF USE

(71) Applicant: Umm Al-Qura University, MAKKAH (SA)

(72) Inventor: ABDULLAH A. FUTINY, MAKKAH (SA)

(21) Appl. No.: 14/929,330

(22) Filed: Oct. 31, 2015

(51) Int. Cl. G06F 3/0354; G06F 3/0484; G06F 17/22; G06F 3/0488

(52) U.S. Cl. CPC G06F 3/03545; G06F 3/04883; G06F 3/04847; G06F 3/04842; G06F 17/2223; G06F 3/04845

(57) ABSTRACT

Practitioners of Arabic calligraphy; such as designers and calligraphers are still seeking to use traditional calligraphy types so as to preserve the heritage of Islamic arts that require the use of traditional calligraphy tools. The present disclosure relates to an electronic computerized calligraphy pen that can be used to practice calligraphy effectively and to overcome long steps used in traditional calligraphy.

### FIELD OF TECHNOLOGY

The present disclosure relates to a calligraphy pen. More specifically, the present disclosure relates to an electronic calligraphy pen for Arabic writing and a method of using the pen.

### BACKGROUND

Arabic text writing requires a specific way of writing which is not possible through regular pen, pencils or other writing modes. A traditional mode of writing Arabic text is through a pen made of dried reed or bamboo which further needs to be cut in a preferred size and angle for writing. This is a complex process and thus needs a lot of training and practice. There is a need for a writing mode which is easy to be used and as effective as traditional mode of writing.

### SUMMARY

The present disclosure related to a calligraphic pen. More specifically the present disclosure relates to an electronic calligraphic pen for writing Arabic text. Further, the disclosure also relates to a method of using the calligraphic pen.

In one embodiment, the present disclosure relates to a device for writing. In another embodiment, the present disclosure relates to a device for writing Arabic text. The device as disclosed is a calligraphic pen. In the entire text the word calligraphic pen and pen are used interchangeably.

In one embodiment, the pen as disclosed is a stylus pen. In another embodiment, the pen as disclosed is an electronic stylus pen.

In one embodiment, the disclosure relates to an electronic calligraphic pen comprising of a head and a body. In another embodiment, the head is detachable. The head can be easily detached and attached to the body by a click before use.

In one embodiment, the head further comprise of a slanted writing device. In another embodiment, the slanted writing device is inclined at an angle as required for Arabic writing. The slanted writing device may be inclined at an angle such as 85, 75 and 55. In yet another embodiment, the slanted writing device as disclosed may be inclined at a different angle as required for Arabic writing. A user can change the head with a desired slanted writing device angle for writing.

In one embodiment, a user may use the head with slanted writing device inclined at 55 degrees for Riqqa font. In another embodiment, the user may use the head with slanted writing device inclined at 85 degrees for Thuluth font. In another embodiment, the user may use the head with slanted writing device inclined at 75 degrees for Naskh font. In another embodiment, Arabic font types, such as Thuluth, Diwani, Naskh, Riqaa, Farsi, etc. may be written using this device.

In one embodiment, the slanted writing device is one device whose angle might be changed or different devices with different slant angles for the user to interchange.

In one embodiment, the stylus pen may be used on an electronic board for writing. In another embodiment, the electronic board may be further connected to a computer for its functioning.

In one embodiment, a computer aided method of using several modules such as pen module, font module, communication module, database module, network module, graphical interface module, display surface module housed in a processor to be used by any mobile device that may allow attachment of the device such a calligraphic pen. The device may be used for desk top computer or mobile phone devices as well. The user may also access the software module for use via internet if the software is stored in a cloud server.

The above mentioned summary presents a simplified version of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. Other aspects will be apparent from the following description, figures and the appended claims.

### BRIEF DESCRIPTION OF THE DRAWINGS

FIG. 1 shows a traditional pen as used in Arabic writing.

FIG. 2 shows a head of the traditional pen clipped at different angles for Arabic writing.

FIG. 3 shows an electronic calligraphic pen with detachable heads.

FIG. 4 shows writing with the disclosed pen onto an electronic board.

FIG. 5 shows output from the calligraphic pen onto a computer screen.

FIG. 6 shows the network architecture for the said system.

FIG. 7 shows the different modules housed in a processor.

FIG. 8 shows a flow chart of the process or method for using the calligraphy pen.

### DETAILED DESCRIPTION

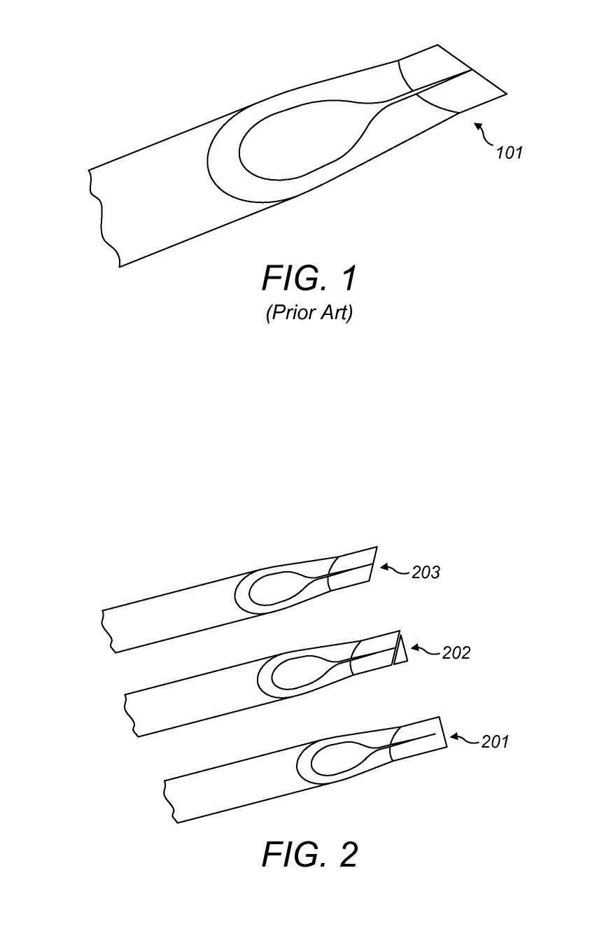

The instant disclosure describes an electronic aided calligraphy pen that has adjustable slanted writing device in one end and attached to a processor that houses software to control the writing device in another end. The pen in one embodiment, may be a standalone device with wireless software capabilities that starts the writing process once the slanted writing device touches a writing surface that is paired with the calligraphy pen. A traditional calligraphy pen as used by calligraphers, designers or students of Arabic calligraphy is made from woven (which is a tubular wooden plant) or from palm trees and sometimes it is called reeds pens (FIG. 1; 101). These kinds of pens have got different widths and different angles according to the font size and type depending on the need of calligraphers for the size and width of the head of the pen.

Every type of calligraphy pen has a different head angle and this is why calligraphers use woven pens for its high accuracy and smoothness as well as its evolving role in highlighting the artistic value of the Arabic character. The three grounds to practice Arabic calligraphy comprise of reed pens, ink to be used and the paper for writing.

### Reed Pens:

The reed pens are used after they are sharpened in a specific way and the width as required and determined by a calligrapher as they need different sizes ranging from (1 mm to 50 mm) (FIGS. 2; 201, 202 and 203). After the pen is sharpened and the width is determined, the head should be clipped in a tilted angle which differs from one font type to another, e.g., the angle of a pen used in Thuluth font is 65 degrees, in Naskh font it is 75 degrees, in Diwani font it is 80 degrees, in Riqaa font it is 85 and in Kufi font it is zero degrees. Further, a small incision should be made at the top of the pen to serve as a reservoir that saves ink and allows it to glide easily on the paper.

### Ink:

For traditional Arabic calligraphy, the granules of Chinese ink should be melted in lukewarm water and put in a glasses container and silk threads should be added to it as well so as to save ink at the head of the pen.

### Paper:

Paper as is used in the traditional Arabic writing should be painted by (Aspidaj) solution or by egg yolk and leave it to dry. By doing this, one ensures non-proliferation of ink while writing.

Practitioners of Arabic calligraphy; such as designers and calligraphers are still seeking to use traditional calligraphy types so as to preserve the heritage of Islamic arts that require the use of traditional calligraphy tools. Nowadays, the use of these traditional tools needs to be developed to suit the rapid development that is imposed by the spirit of this era.

Thus, the present disclosure relates to a calligraphic pen which can be used for Arabic writing, is easy to use and is same as writing through a traditional way.

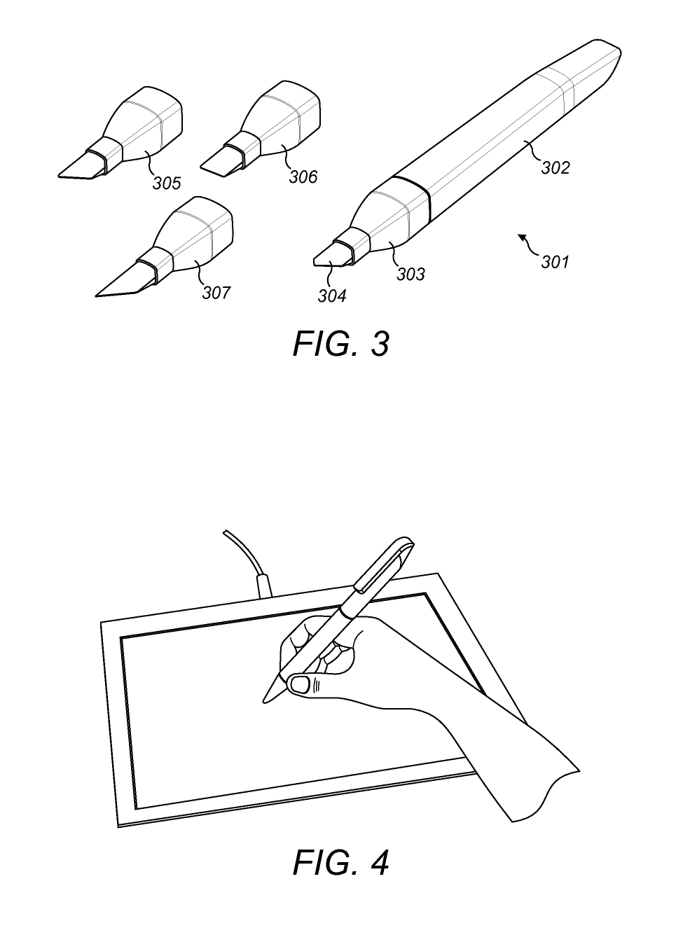

The disclosure relates to a pen which is an electronic calligraphic pen 301. As shown in FIG. 3, the pen as disclosed comprises of a body 302 and a head 303. The head 303 as disclosed further comprise of a slanted writing device 304. The slanted writing device may be inclined at a different angle as and when required by a calligrapher (305, 306 and 307). The head can be attached and detached to the body which heals a calligrapher to choose the width or angle of the slanted writing device and the font for writing.

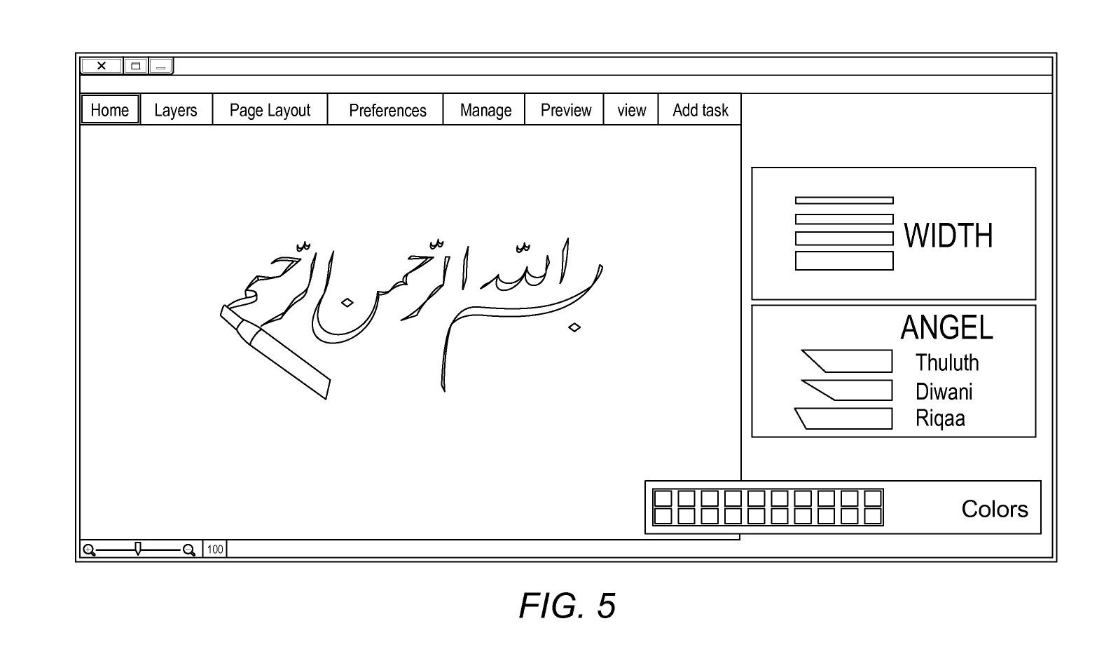

The pen as disclosed is a stylus pen and thus can be used on an electronic board. A user may select a head, hold the pen and write onto the electronic board as shown in FIG. 4. The input on the electronic board is then transmitted onto the computer screen (FIG. 5).

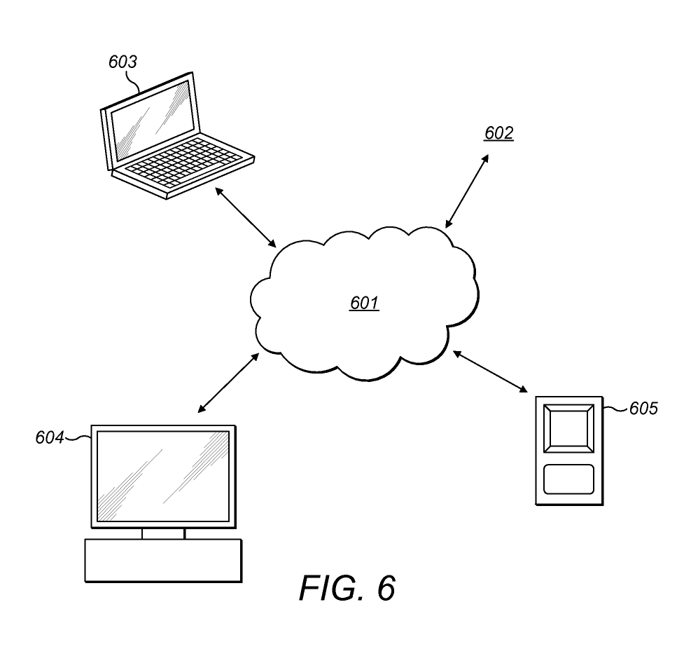

Referring to FIG. 6, the electronic board or computer screen shown in FIG. 5 may be embodied in one or more computing devices such as a laptop computer 603, a desktop computer 604, a portable phone 605, a computer tablet or any device incorporating a computer screen. These computing devices may be connected to a network 601, such as a LAN network. The network 601 may be connected to an external network 602 such as the Internet.

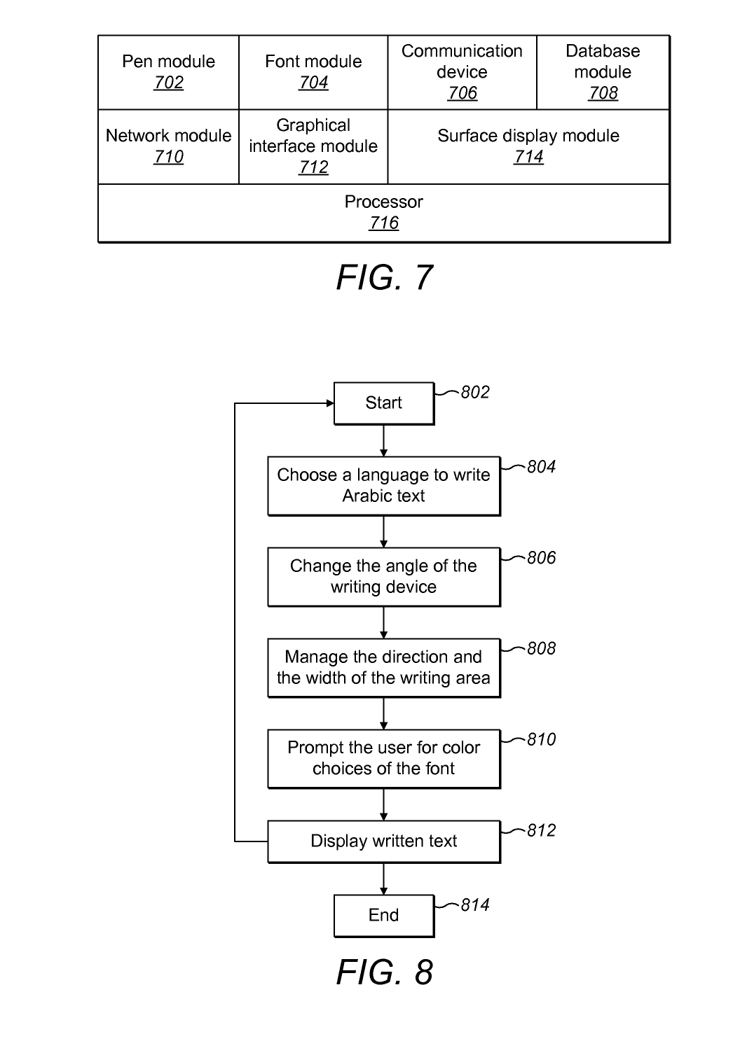

Referring to FIG. 7, software installed in one or more of the computing devices interacts with at least one processor 716 coupled to at least one memory for storing program instructions supporting different modules such as a pen module 702, a font module 704, a communication device module 706, a database module 708, a network module 710, a graphical interface module 712, and a surface display module 714.

Referring to FIG. 8, there are shown steps of using a stylus pen with a software application. In a first step, the method begins in step 802, followed by choosing a language to write Arabic text in step 804, then changing the angle of the writing device in step 806, then managing the direction and the width of the writing area in step 808, then prompting the user for choices of the font in step 810, then displaying written text in step 812, and ending the method in step 814.

Although the present embodiments have been described with reference to specific example embodiments, it will be evident that various modifications and changes may be made to these embodiments without departing from the broader spirit and scope of the various embodiments. Accordingly, the specification and drawings are to be regarded in an illustrative rather than a restrictive sense.

What is claimed is:

1. An electronic calligraphic pen, comprising:
a head;
a writing device; and
a body, wherein the electronic calligraphic pen is for writing on a computer screen, the computer screen being configured to receive input commands from the writing device of the electronic calligraphic pen, the input commands comprising an angle information selectable by a given user by means of one or more computing devices associated with the given user, the angle information being changeable by the given user to change an angle of the writing device displayed on the computer screen so that text displayed on the computer screen corresponds to the changed angle of the writing device.

2. The electronic calligraphic pen as disclosed in claim 1, wherein the pen is used for Arabic writing.

3. The electronic calligraphic pen as disclosed in claim 1, wherein the head is detachably connected to the writing device.

4. The electronic calligraphic pen as disclosed in claim 1, wherein the pen is a stylus pen.

5. The electronic calligraphic pen as disclosed in claim 3, wherein the writing device is inclined at an angle for writing.

6. The electronic calligraphic pen as disclosed in claim 5, wherein the slanted writing device is inclined at an angle of one of 85, 75 and 55 degrees.

7. The electronic calligraphic pen as disclosed in claim 1, wherein the pen is configured to write onto an electronic board.

8. The calligraphic pen as disclosed in claim 7, wherein the electronic board is further connected to a computer.

9. A system comprising:
a stylus pen including a writing device;
a computer screen for receiving input commands from the writing device of the stylus pen;
a memory;
one or more processors coupled to the memory, wherein the memory comprises program instructions to:
receive an angle information selected by a given user from one or more computing devices associated with the given user;
change an angle of the writing device for the given user based on the angle information; and
display text on the computer screen corresponding to the changed angle of the writing device.

10. The system of claim 9, wherein the program instructions are configured to receive a language information chosen by the given user to write Arabic text.

11. The system of claim 10, wherein the program instructions are configured to receive a direction and width information of text chosen by the given user to write Arabic text.

12. The system of claim 10, wherein the program instructions are configured to receive a colour information chosen by the given user to write Arabic text.

13. A computer-implemented method comprising:
receiving input commands from a writing device of a stylus pen being applied to a computer screen by a given user;
receiving an angle information selected by the given user from one or more computing devices associated with the given user;
changing an angle of the writing device for the given user based on the angle information selected by the given user; and
displaying text on the computer screen corresponding to the changed angle of the writing device.

14. The computer-implemented method of claim 13, further comprising receiving a language information chosen by the given user to write Arabic text.

15. The computer-implemented method of claim 13, further comprising receiving a direction and width information of text chosen by the given user to write Arabic text.

16. The computer-implemented method of claim 13, further comprising receiving a colour information chosen by the given user to write Arabic text.
